(19) United States
(12) Patent Application Publication
(10) Pub. No.: US 2019/0325429 A1
(43) Pub. Date: Oct. 24, 2019

(54) PUSH PAYMENTS TO VIRTUAL PAYMENT CARD NETWORK ACCOUNTS

(71) Applicant: MASTERCARD INTERNATIONAL INCORPORATED, PURCHASE, NY (US)

(72) Inventors: Donghao Huang, Singapore (SG); Mikel J Irkliewskij, Lagrange, NY (US); Hao Tang, Singapore (SG); Bensam Joyson, Singapore (SG)

(21) Appl. No.: 16/387,988

(22) Filed: Apr. 18, 2019

Related U.S. Application Data
(60) Provisional application No. 62/659,850, filed on Apr. 19, 2018.

(51) Int. Cl. G06Q 20/34; G06Q 20/14

(52) U.S. Cl. CPC G06Q 20/351; G06Q 20/14

(57) ABSTRACT

A request for a payment transaction is received. The request originates from a user. The request includes a token. The token represents a virtual card account. The virtual card account is associated with a merchant's master account. The payment transaction is for crediting the merchant's master account. The virtual card account is associated with a purpose for the payment transaction. The request is mapped to the purpose for the transaction. After the mapping, a message is transmitted to the merchant. The message indicates: (a) that the payment transaction has occurred; and (b) the purpose for the transaction.

### CROSS REFERENCE TO RELATED APPLICATION

This application claims the benefit of U.S. Provisional Patent Application No. 62/659,850 (filed on Apr. 19, 2018); the contents of which provisional application are hereby incorporated by reference for all purposes.

### BACKGROUND

Payment card networks are deployed widely. In many typical transactions, the merchant initiates the transaction using information supplied from a customer device (e.g., a payment account card), and funds are pulled from the customer's payment card account to an acquirer bank that serves the merchant.

More recently, so-called “push payment” systems have been deployed, in which the customer initiates a payment to a merchant via the customer's bank (i.e., via the bank that issued the customer's payment card account). Such systems may be very favorable to merchants, who may thereby be able to minimize or even eliminate investments in merchant equipment at the point of sale.

The present inventors have now recognized opportunities to make push payment P2M (person-to-merchant) systems still more advantageous from the point of view of merchants, including applications to the so-called Internet of Things (IoT) and billing services or the like.

### BRIEF DESCRIPTION OF THE DRAWINGS

Features and advantages of some embodiments, and the manner in which the same are accomplished, will become more readily apparent with reference to the following detailed description taken in conjunction with the accompanying drawings, which illustrate exemplary embodiments, wherein:

FIG. 1 is a block diagram illustrating a conventional payment card account system in which a P2M push payment is performed.

FIG. 2 is a diagram that illustrates a payment transaction system provided according to aspects of this disclosure.

FIG. 3 is a block diagram that illustrates a computer system that may perform functions in the system of FIG. 2.

FIG. 4 is a block diagram that illustrates another computer system that may perform functions in the system of FIG. 2.

FIG. 5 is a simplified block diagram that illustrates a typical mobile device that may be operated by a user/customer in the system of FIG. 2.

FIG. 6 is a flow chart that illustrates a process that may be performed in the system of FIG. 2 in accordance with some aspects of the disclosure.

### DETAILED DESCRIPTION

In general, and for the purpose of introducing concepts of novel embodiments described herein, virtual payment accounts are put in place for specific purposes (such as device usage, bill payment, etc.) established by a merchant. For example, a virtual payment account may correspond to a particular pay-to-use device provided by a merchant for customer service. In other applications, a virtual payment account may correspond to a particular customer account, or a particular invoice or bill rendered by the merchant to the customer. Tokens are issued to represent the virtual accounts and are mapped to the specific purpose for the prospective payment. The customer may initiate a push payment using a token. The payment is credited to the merchant's master payment card system account, and the merchant is informed of the purpose that the payment was intended to satisfy.

P2M payments may, with this arrangement, facilitate bill payments, use of vending machines and laundromat facilities and a whole host of other use cases where credit card transactions are used (or desired to be used) to replace cash payments or payment by check.

Throughout this disclosure, examples of financial transactions will be described, which are not to be taken as limiting. In addition, a number of terms will be used, the use of which terms is not intended to be limiting, but rather the terms are used for convenience and ease of exposition. For example, as used herein, the term “user” may be used interchangeably with the term “consumer” and/or the with the term “cardholder” and/or with the term “customer” and these terms are used herein to refer to a person, individual, consumer, customer, company, business or other entity that owns (or is authorized to use) a financial account such as a bank account (i.e., a savings account and/or a checking account) or payment card account (i.e., a credit card account, debit card account, or pre-paid card account) or some other type of financial account (such as a brokerage account, loyalty card account, and/or mass transit access account). In addition, the term “payment card account” may include a credit card account, a debit card account, and/or a deposit account or other type of financial account that an account holder or cardholder may access. The term “payment card account number” includes a number that identifies a payment card system account or a number carried by a payment card, and/or a number that is used to route a transaction in a payment system that handles debit card and/or credit card transactions and the like. Moreover, as used herein the terms “payment card system” or “payment card account system” refer to a system and/or network for processing and/or handling purchase transactions and related transactions, which may be operated by a payment card system operator such as Mastercard International Incorporated (the assignee hereof), or a similar system. In some embodiments, the term “payment card system” may be limited to systems in which member financial institutions (such as banks) issue payment card accounts to individuals, businesses and/or other entities or organizations (and thus are known as issuer financial institutions or issuer banks). In addition, the terms “payment card system transaction data” and/or “payment card network transaction data” or “payment card transaction data” refer to transaction data associated with payment or purchase transactions that have been or are being processed over and/or by a payment card network or payment card account system. For example, payment card system transaction data may include a number of data records associated with individual payment transactions (or purchase transactions) of cardholders that have been processed over a payment card system or payment card network. In some embodiments, payment card system transaction data may include information such as data that identifies a cardholder, data that identifies a cardholder's payment device and/or payment card account, transaction date and time data, transaction amount data, an indication of the merchandise or services that have been purchased, and information identifying a merchant and/or a merchant category. Additional transaction details and/or transaction data may also be available and/or utilized for various purposes in some embodiments.

As used herein and in the appended claims, the term “purpose for the payment transaction” refers to a device to be actuated in response to the payment transaction or a bill or customer account (not a payment card system account) to be credited as a result of the payment transaction.

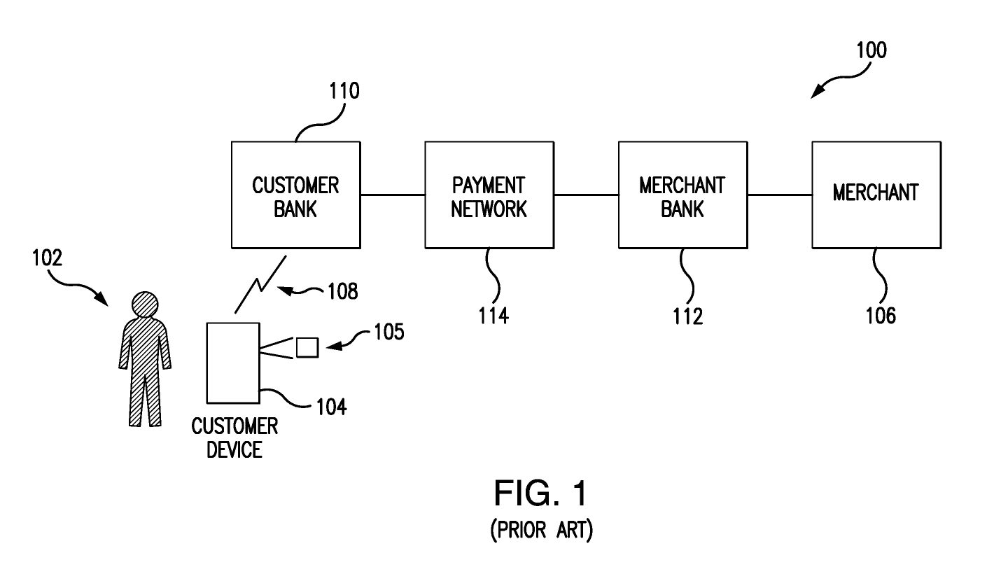

FIG. 1 is a block diagram illustrating a conventional payment card account system 100 in which a P2M push payment is performed.

FIG. 1 shows a user/customer 102 of the system 100. The user 102 is shown interacting with a customer device 104, which may be a payment-enabled mobile device owned by the user 102. It is assumed that the user 102 is at a merchant's point of sale (not expressly depicted) and uses the customer device 104 to scan a QR (quick response) code (schematically indicated at 105) presented by the merchant 106 to launch a P2M payment transaction. Launching of the transaction proceeds with over-the-air communication 108 from the customer device 104 to the customer bank 110 (payment card account issuer), at which the funding account for the transaction is held. The customer bank 110 and the merchant bank 112 are linked via a payment card network 114, to support a push transaction from the user's account to the merchant's account (payment card network account) at the merchant bank 112. The merchant bank 112 notifies the merchant 106 that the payment transaction has been accomplished, and the transaction between the user and the merchant at the point of sale is completed.

The payment network 114 may be, for example, the type of system operated by Mastercard International Incorporated, which is the assignee hereof.

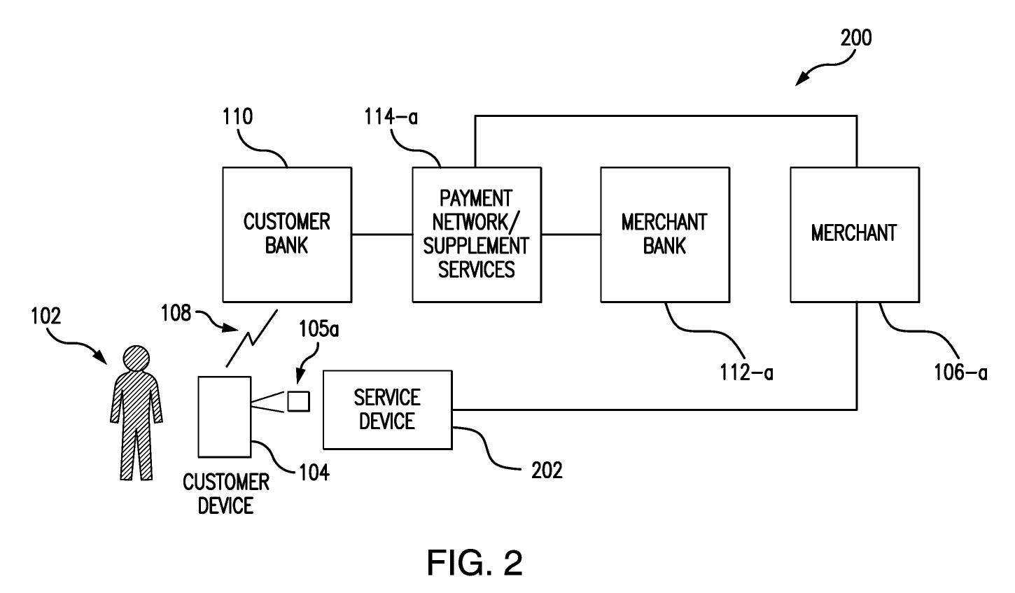

FIG. 2 is a diagram that illustrates a payment transaction system 200 provided according to aspects of this disclosure. FIG. 2 illustrates what may be referred to as a “vending” use case; i.e., the user wishes to obtain goods or services from a service device 202, which may be a vending machine, a clothes washing machine at a laundromat, a parking meter, a pre-paid source of electrical energy, etc. Other example use cases will be discussed below. The service device is operated by a merchant 106-a.

A QR code (schematically illustrated at 105-a) is associated with (e.g., displayed on) the service device 202. As before, the user 102 interacts with his/her customer device 104 to scan the QR code 105-a and to wirelessly communicate 108 with the customer bank 110 in order to launch a P2M payment transaction according to principles of this disclosure.

As will be seen, the QR code 105-a may provide to the customer device 104 data that corresponds to a payment token. It is assumed that the payment token represents a virtual payment card system account that has been mapped to the particular service device 202. The virtual payment card system account also corresponds to a master payment card system account for the merchant 106-a. The merchant's master payment card system account is the account to which the P2M push payment is to be credited.

In addition to the customer bank 110, the payment system 200 also includes a payment network/supplemental services entity 114-a which facilitates the P2M transaction between the customer bank 110 and a merchant bank 112-a that serves as acquirer bank for the merchant 106-a. In the particular type of embodiment illustrated in FIG. 2, the payment network/supplemental services entity 114-a holds mappings of tokens/virtual payment card accounts to particular service devices and to the merchant's master payment card account.

Referring again to FIG. 2, each block therein may generally be taken to represent an indicated entity and/or one or more computer systems operated by the respective entity. Lines connecting blocks in FIG. 2 may be taken to represent data communication channels between computers. It may be assumed that the service device 202 contains suitable processing and memory components (not separately shown) to enable the service device to be deployed in the context of an IoT application.

The system components shown in FIG. 2 are only those needed for a single transaction. In a practical embodiment of the payment system 200, there may be many users and their devices, numerous financial institutions acting as either or both of customer banks and merchant banks, and a large number of merchants, with each merchant operating numerous service devices.

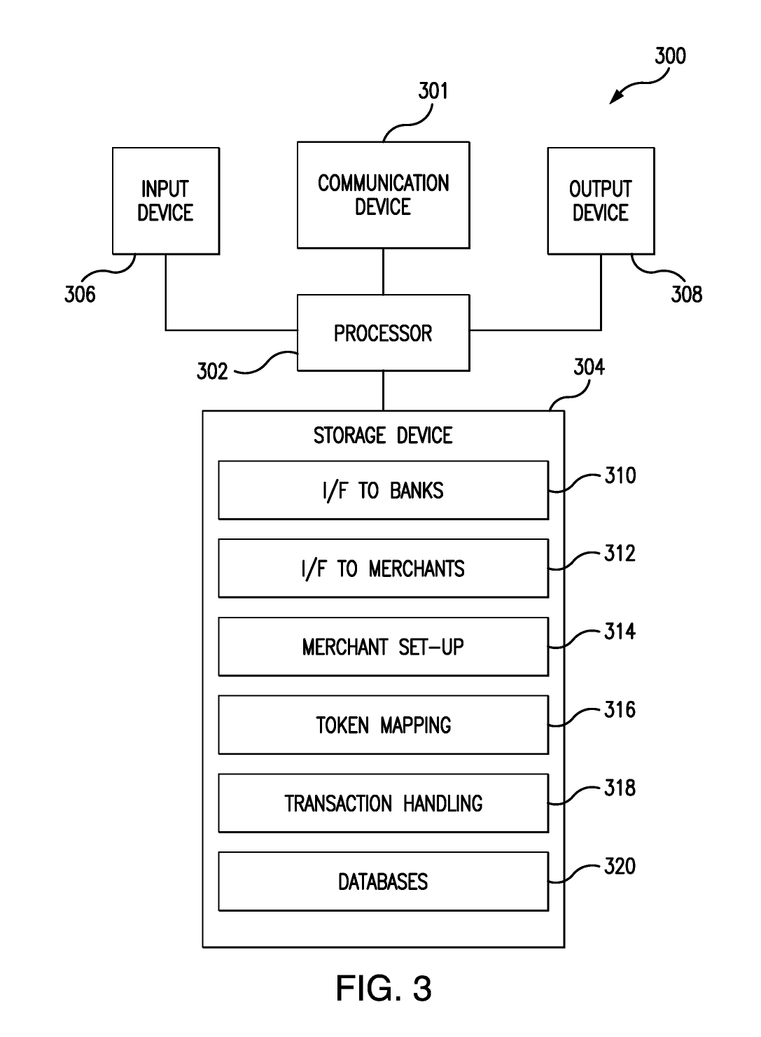

FIG. 3 is a block diagram of an example computer system 300 that may implement some or all of the functionality ascribed herein to the payment network/supplemental services entity 114-a. As such, the computer system 300 may be referred to as a “payment network computer.”

Referring then to FIG. 3, the payment network computer 300 may, in its hardware aspects, resemble a typical server computer and/or mainframe computer, but may be controlled by software to cause it to function as described herein. In addition, the payment network computer 300 may be designed as a special purpose computer, and thus specially configured to perform the functions described herein.

The payment network computer 300 may include one or more processor(s) 302 operatively coupled to a communication device 301, a storage device 304, an input device 306 and an output device 308. The communications device 301, the storage device 304, the input device 306 and the output device 308 may all be in communication with and/or operably connected to the processor(s) 302. The processor(s) 302 operate to execute processor-executable steps, contained in program instructions described below, so as to control the payment network computer 300 to provide desired functionality.

Communication device 301 may be used to facilitate communication with, for example, other devices (such as computing devices operated by customer and merchant banks and by merchants). Communication device 301 may comprise numerous communication ports (not separately shown), to allow the payment network computer 300 to communicate simultaneously with a number of other computers and/or other devices, including communications as required to simultaneously handle numerous interactions with other devices which may be associated with numerous push payment and other transactions.

Input device 306 may comprise one or more of any type of peripheral device typically used to input data into a computer. For example, the input device 306 may include a keyboard and a mouse. Output device 308 may comprise, for example, a display and/or an audio speaker, and/or a printer.

Storage device 304 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as flash memory and the like. Any one or more of such information storage devices may be considered to be a non-transitory computer-readable storage medium or a computer usable medium or a memory.

Storage device 304 stores one or more programs for controlling the processor(s) 302. The programs comprise program instructions (which may be referred to as computer readable program code means) that contain processor-executable process steps of the payment network computer 300, executed by the processor(s) 302 to cause the payment network computer 300 to function as described herein.

The programs may include one or more conventional operating systems (not shown) that control the processor(s) 302 so as to manage and coordinate activities and sharing of resources in the payment network computer 300, and to serve as a host for application programs (described below) that run on the payment network computer 300.

The programs stored in the storage device 304 may include, for example, a software interface 310 to facilitate communication between the payment network computer 300 and customer and/or merchant bank computers.

Another program that may be stored in the storage device 304 is a software interface 312 to support communication between the payment network computer 300 and the computers operated by merchants.

The storage device 304 may also store a merchant enrollment and set-up application program 314. The merchant enrollment application program 314 may control the processor(s) 302 to enable the payment network computer 300 to handle enrollment of merchants in a targeted push payment service such as is described herein.

Further, the storage device 304 may store a token mapping application program 316. The token mapping application program 316 may allow set up for and use of mapping of tokens/virtual payment card accounts to particular service devices for which targeted push payments are to be received.

In addition, the storage device 304 may store a transaction handling application program 318. The transaction handling application program 316 may control the processor(s) 302 to enable the payment network computer 300 to play its role in push payment transactions such as those described above.

The storage device 304 may also store, and the processor(s) 302 may also execute, other programs, which are not shown. For example, such programs may include communications software and one or more reporting applications. The latter program(s) may respond to requests from system administrators, for example, for reports on the activities performed by the payment network computer 300. The other programs may also include, for example, web hosting software, device drivers, database management software, and the like.

The storage device 304 may also store one or more databases 320 that may be required for operation of the payment network computer 300.

It should be understood that other computerized components of the system 200 (FIG. 2) may be constituted by computer hardware having the same types of components and/or hardware architecture as described herein with reference to FIG. 3.

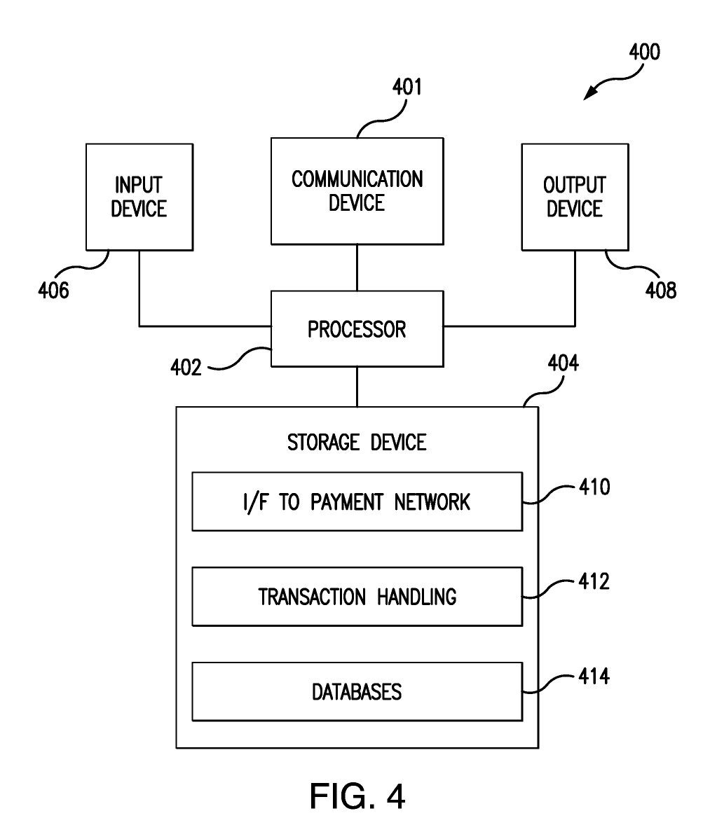

FIG. 4 is a block diagram of an example computer system 400 that may implement some or all of the functionality ascribed herein to the merchant (FIG. 2). As such, the computer system 400 may be referred to as a “merchant computer.” The merchant computer 400 may have the same type of hardware architecture and the same kinds of hardware components that were described above in relation to the payment network computer 300.

Accordingly the merchant computer 400 (as depicted in FIG. 4) may include one or more processor(s) 402 operatively coupled to a communication device 401, a storage device 404, an input device 406 and an output device 408. The communications device 401, the storage device 404, the input device 406 and the output device 408 may all be in communication with and/or operably connected to the processor(s) 402. The processor(s) 402 operate to execute processor-executable steps, contained in program instructions described below, so as to control the merchant computer 400 to provide desired functionality.

Storage device 404 stores one or more programs for controlling the processor(s) 402. The programs comprise program instructions (which may be referred to as computer readable program code means) that contain processor-executable process steps of the merchant computer 400, executed by the processor(s) 402 to cause the merchant computer 400 to function as described herein.

The programs may include one or more conventional operating systems (not shown) that control the processor(s) 402 so as to manage and coordinate activities and sharing of resources in the merchant computer 400, and to serve as a host for application programs (described below) that run on the merchant computer 400.

The programs stored in the storage device 404 may include, for example, a software interface 410 to facilitate communication between the merchant computer 400 and the payment network computer 300.

The storage device 404 may also store a transaction handling application program 412. The transaction handling application program 412 may control the processor(s) 402 to enable the merchant computer 400 to receive notification of, and respond appropriately to, push payment transactions such as those described herein.

The storage device 404 may also store, and the processor(s) 402 may also execute, other programs, which are not shown. For example, such programs may include communications software and one or more reporting applications. The latter program(s) may respond to requests from system administrators, for example, for reports on the activities performed by the merchant computer 400. The other programs may also include, for example, device drivers, database management software, and the like.

The storage device 404 may also store one or more databases 414 that may be required for operation of the merchant computer 400.

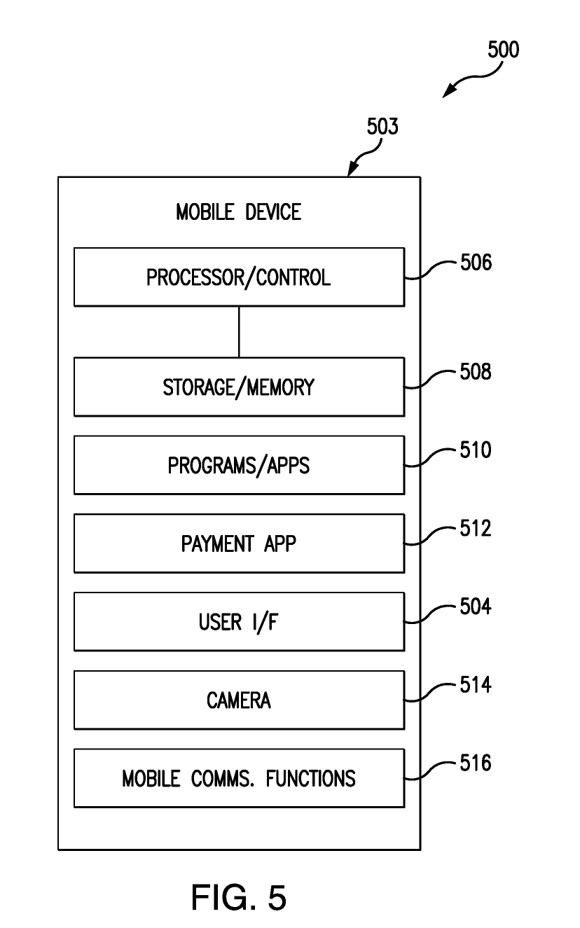

FIG. 5 is a simplified block diagram that illustrates a typical mobile device 500 that may be operated by a user/customer 102 in the payment system 200 of FIG. 2; that is, the mobile device 500 is an example embodiment of the customer device 104 shown in FIG. 2.

Referring to FIG. 5, the mobile device 500 may include a housing 503. In many embodiments, the front of the housing 503 is predominantly constituted by a touchscreen (not separately shown), which is a key element of the user interface 504 of the mobile device 500.

The mobile device 500 further includes a mobile processor/control circuit 506, which is contained within the housing 503. Also included in the mobile device 500 is a storage/memory device or devices (reference numeral 508). The storage/memory devices 508 are in communication with the processor/control circuit 506 and may contain program instructions to control the processor/control circuit 506 to manage and perform various functions of the mobile device 500. As is well-known, a device such as mobile device 500 may function as what is in effect a pocket-sized personal computer (assuming for example that the mobile device is a smartphone), via programming with a number of application programs, or “apps”, as well as a mobile operating system (OS). (The apps are represented at block 510 in FIG. 5, and may, along with other programs, in practice be stored in block 508, to program the processor/control circuit 506.)

Because of its particular relevance to the subject matter of this disclosure, one of the apps—namely a payment app—is represented in the drawing as block 512, separate from the other apps 510. The payment app 512 may program the mobile device 500 to perform functionality as required to initiate P2M push payments as described herein.

Block 514 in FIG. 5 represents a digital camera, such as is typically included among the features of a smartphone. As is known, the digital camera 514 may be used to scan a QR code (e.g., a QR code associated with a service device), thereby obtaining data needed for the processor 506/payment app 512 to initiate a P2M push payment.

As is typical for mobile devices, the mobile device 500 may include mobile communications functions as represented by block 516. The mobile communications functions may include voice and data communications via a mobile communication network with which the mobile device 500 is registered.

From the foregoing discussion, it will be appreciated that the blocks depicted in FIG. 5 as components of the mobile device 500 may in effect overlap with each other, and/or there may be functional connections among the blocks which are not explicitly shown in the drawing. It may also be assumed that, like a typical smartphone, the mobile device 500 may include a rechargeable battery (not shown) that is contained within the housing 503 and that provides electrical power to the active components of the mobile device 500.

It has been posited that the mobile device 500 may be embodied as a smartphone, but this assumption is not intended to be limiting, as mobile device 500 may alternatively, in at least some cases, be constituted by a tablet computer or by other types of mobile computing devices.

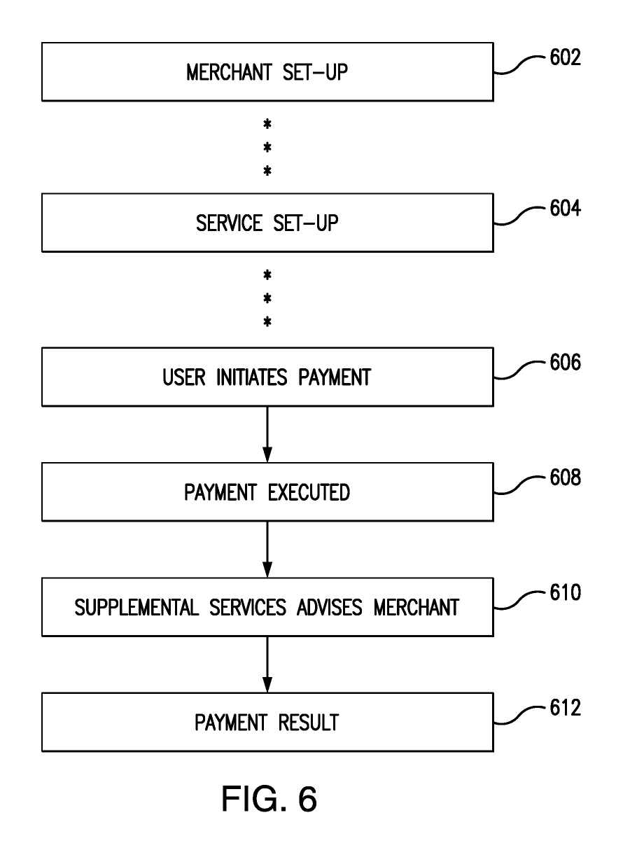

FIG. 6 is a flow chart that illustrates a process that may be performed in the payment system 200 of FIG. 2 in accordance with some embodiments of the disclosure.

At 602 in FIG. 6, a merchant may interact with the payment network computer 300 in order to enroll in a service offering that allows the merchant 106-a to obtain virtual “targeted” (or “single purpose”) payment card accounts for use in P2M push transactions as described herein. (In some embodiments, some or all of the exchange of information between the merchant and the payment network computer 300 may alternatively take place via the merchant bank 112-a.) The merchant may establish an account for receiving P2M payments as described herein. In some embodiments, the payment network computer 300 may query the merchant bank 112-a to obtain a PAN (primary account number) which will identify the merchant's master payment card account at the merchant bank 112-a for receiving P2M push payments. As part of the set-up process, the merchant 106-a may be registered by a token/virtual account life cycle management service (provided by or associated with the payment network computer 300) that will allow the merchant to add and delete “purposes” for which P2M push payments are to be received.

At 604, the merchant 106-a may interact with the payment network computer 300 to add a service device to the merchant's P2M account. In effect, the merchant 106-a is requesting a token that can be used to identify P2M payments as pertaining to the service device in question. The merchant 106-a may include the token in the QR code 105-a associated with the service device in question. The payment network computer 300 may map the token to the merchant's P2M PAN and also to a device identifier that the merchant may use to identify the service device in question.

At 606, the user 102 may initiate a P2M payment transaction to obtain service (or purchase an item) from the service device 202 (FIG. 2). For example, the user 102 may scan the QR code 105-a to obtain access to an operating cycle of the service device 202, in the case where the service device 202 is a washing machine at a laundromat. The QR code may indicate both the token that has been mapped to the service device 202 and also the monetary amount charged for the machine operating cycle. The customer device 104 communicates wirelessly with the customer bank 110 to launch the P2M payment. The data communicated from the customer device 104 to the customer bank 110 may include the monetary amount and the token, as well as the user's payment account number. In some embodiments, or in some situations, the user may enter the monetary amount (transaction amount) into the customer device by interacting with a numeric keypad or virtual numeric keypad on the customer device. The latter manner of supplying the transaction amount may be referred to herein and in the appended claims as “entering numerically” the transaction amount.

At 608, the customer bank 110 communicates with the payment network computer 300 to execute the P2M payment transaction. The messaging from the customer bank 110 to the payment network computer 300 includes the token provided in the user's message to the customer bank 110 and also includes the transaction amount. The payment network computer 300 in effect detokenizes the token to obtain the PAN for the merchant payment card system account, so that the transaction amount is credited to the merchant's master payment card account at the merchant bank 112-a. At the same time, the payment network computer 300 maps the token to the particular service device that corresponds to the token (and that the user wishes to access). The mapping may include using the token to look up the service device identifier. At 610, the payment network computer 300 uses the service device identifier to indicate to the merchant that access should be provided to the service device in question. At 612, the merchant may activate the service device so that the user obtains the desired access. In one use case, this could mean that the service device is a laundromat clothes washing machine and that the user is allowed to operate a cycle of the washing machine. In another use case, the service device is a vending machine, and it makes a requested item available to the user. In still another use case, the service device is an air conditioner in a rented room, and the access involves the air conditioner going into operation for a pre-determined period of time. In yet another use case, the service device includes a battery or other source of electrical power, and the access to the service device provides a predetermined quantity of electrical power for use by the user. For another use case, the service device is a parking meter and the access allowed is addition of time, or documentation of time, in connection with the meter, to permit parking in an associated or designated parking space.

In addition to the use cases related to service devices, as described above, the payment system 200 may embody other types of use cases as well. For example, in a bill payment use case, the user's bill (say a utility bill) for a service may display a QR code. The bill may be electronic or presented on paper. The QR code may contain a token that corresponds to the particular bill in question or to the user's account with the merchant. The QR code also may contain data that indicates the bill amount, which becomes the transaction amount for the P2M push payment. The steps as shown in FIG. 6 and as described above may be performed, with the variation that the payment network computer 300 maps the token to the bill identifier or user account number (i.e., the user account number with the merchant), as the case may be, and then advises the merchant that the particular bill has been paid, or that the customer's account with the merchant should be credited with the transaction amount.

In embodiments described herein, the customer device 104 obtains the token and transaction amount for the P2M transaction by scanning a QR code. However, as a possible alternative, the customer device 104 may read an RFID (radio frequency identification) tag associated with the service device in order to obtain the token and the transaction amount for the P2M transaction. As still another alternative, the service device may communicate the token and the transaction amount to the customer device via short range radio data communication such as NFC (near field communication) or another communication protocol.

According to another alternative, the user may be provided with a numeric code (e.g., an eight-digit number) to enter into the customer device to launch the P2M payment.

With processes as described herein, the payment system 200 conveniently applies P2M push payment techniques to use cases such as device access or bill payment, while providing the merchant with data needed to identify the device to be accessed by the user, or the bill or customer account to which the P2M payment pertains.

In regard to the token life cycle, the merchant may request issuance of a token when a service device is made available for access transactions. The token is then mapped in the records of the payment network computer 300 to the service device identifier provided by the merchant, and is provided to the merchant to associate with the service device for being provided to the user who requests access. When the service device is retired, the merchant may request the payment network computer 300 to terminate the virtual payment account that corresponds to the token. The computer then deletes the previous mapping from the token to the service device identifier and the token becomes available for recycling.

Where tokens are mapped to specific bills presented by the merchant to customers, the merchant may request a token for each bill to be rendered. The payment network computer 300 may map the token in its records to the bill identifier and may provide the token to the merchant for inclusion in the bill. The token, once used, is recycled, and the mapping to the bill in question is deleted.

The merchant may also request a virtual account/token for each customer account, and the mapping of token to customer account may be maintained in the records of the payment network computer 300 so long as the customer continues to maintain an account with the merchant.

In a variation on the process of FIG. 6, the merchant bank may hold the mapping of the token to the merchant master payment card account. The payment network computer 300 may send the P2M transaction through (with the token) to the merchant bank. The merchant bank may then credit the merchant's master payment card account, and communicate back to the payment network computer 300 that the token had been successfully used to complete the P2M payment transaction. At that point, the payment network computer 300 may then map the token to the service device, bill identifier or merchant/customer account identifier, as the case may be, and the payment network computer 300 may advise the merchant to allow device access, or credit payment to the bill or account.

In embodiments described herein, the payment network holds the mapping of tokens to service device identifiers and/or bill identifiers, etc., and communicates such identifiers to the merchant for implementation of the purpose of the P2M payment transactions.

Alternatively, however, the merchant may hold the mappings of tokens/VCNs to device identifiers, bill identifiers, etc., and may receive the pertinent token/VCN from the payment network to trigger implementation of the purpose of the payment transaction.

From the foregoing discussion, it will be appreciated that the payment system 200 is a computerized, electronic, networked and distributed computer to computer messaging system that causes funds to be transferred from party to party by data messaging according to pre-arranged protocols provided in accordance with teachings of the present disclosure. The system 200 expands the capabilities of the payment system and provides enhanced data messaging features from computer to computer to support IoT, bill pay or other enhanced applications of P2M payments. Accordingly, the present disclosure provides a technological solution to the technological problem of providing data processing integration of service/account identification processing into a P2M push payment system.

The above descriptions and illustrations of processes herein should not be considered to imply a fixed order for performing the process steps. Rather, the process steps may be performed in any order that is practicable, including the omission of one or more steps and/or the simultaneous performance of at least some steps.

As used herein, the term “computer” should be understood to encompass a single computer or two or more computers in communication with each other.

As used herein, the term “processor” should be understood to encompass a single processor or two or more processors in communication with each other.

Although the present disclosure has been described in connection with specific exemplary embodiments, it should be understood that various changes, substitutions, and alterations would be apparent to those skilled in the art and can be made to the disclosed embodiments without departing from the spirit and scope of the disclosure as set forth herein.

What is claimed is:

1. A method comprising:
receiving a request for a payment transaction, the request originating from a user, the request including a token, the token representing a virtual card account, the virtual card account associated with a merchant's master account, the payment transaction for crediting the merchant's master account, the virtual card account associated with a purpose for the payment transaction;
mapping the request to the purpose for the payment transaction; and
after said mapping, transmitting a message to the merchant, the message indicating: (a) that the payment transaction has occurred; and (b) the purpose for the payment transaction.

2. The method of claim 1, wherein the purpose for the payment transaction is actuation of a service device.

3. The method of claim 2, wherein the service device is a vending machine.

4. The method of claim 2, wherein the service device is a piece of laundry equipment.

5. The method of claim 2, wherein the service device is a parking meter.

6. The method of claim 2, wherein the token was obtained by the user by scanning a barcode displayed on the service device.

7. The method of claim 1, wherein the purpose for the payment transaction is payment of a bill rendered to the user by the merchant.

8. The method of claim 7, wherein the token was obtained by the user by scanning a barcode displayed on the bill.

9. The method of claim 1, wherein the purpose for the payment transaction is payment of at least a portion of a balance due on an account payable to the merchant by the user.

10. The method of claim 1, wherein the request includes a payment amount.

11. The method of claim 10, wherein the payment amount was entered numerically on a mobile device by the user.

12. A method comprising:
receiving a request for a payment transaction, the request originating from a user, the request including a token, the token representing a virtual card account, the virtual card account associated with a merchant's master account, the payment transaction for crediting the merchant's master account, the virtual card account associated with a purpose for the payment transaction; and
transmitting a message to the merchant, the message indicating that the payment transaction has occurred and including the token.

13. The method of claim 12, wherein the purpose for the payment transaction is actuation of a service device.

14. The method of claim 12, wherein the purpose for the payment transaction is payment of a bill rendered to the user by the merchant.

15. An apparatus comprising:
a processor; and
a memory in communication with the processor, the memory storing program instructions, the processor operative with the program instructions to perform functions as follows:
receiving a request for a payment transaction, the request originating from a user, the request including a token, the token representing a virtual card account, the virtual card account associated with a merchant's master account, the payment transaction for crediting the merchant's master account, the virtual card account associated with a purpose for the payment transaction;
mapping the request to the purpose for the payment transaction; and
after said mapping, transmitting a message to the merchant, the message indicating: (a) that the payment transaction has occurred; and (b) the purpose for the payment transaction.

16. The apparatus of claim 15, wherein the purpose for the payment transaction is actuation of a service device.

17. The apparatus of claim 16, wherein the service device is a vending machine.

18. The apparatus of claim 16, wherein the service device is a piece of laundry equipment.

19. The apparatus of claim 15, wherein the purpose for the payment transaction is payment of a bill rendered to the user by the merchant.

20. The apparatus of claim 15, wherein the purpose for the payment transaction is payment of at least a portion of a balance due on an account payable to the merchant by the user.
